(19) United States
(12) Patent Application Publication
(10) Pub. No.: US 2022/0394951 A1
(43) Pub. Date: Dec. 15, 2022

(54) COLLAPSIBLE ENCLOSURE SYSTEM

(71) Applicant: ZEN HABITATS, INC., HULL, MA (US)

(72) Inventor: Randy Williams, Hull, MA (US)

(73) Assignee: ZEN HABITATS, INC., Hull, MA (US)

(21) Appl. No.: 17/841,630

(22) Filed: Jun. 15, 2022

Related U.S. Application Data
(60) Provisional application No. 63/210,945, filed on Jun. 15, 2021.

(51) Int. Cl. A01K 1/02

(52) U.S. Cl. CPC A01K 1/0245

(57) ABSTRACT

A collapsible enclosure system is provided having end walls and hingedly coupled side walls whereby the end walls and side walls are configured to couple and define an enclosure area to retain a living creature. In some embodiments, the side walls define a top wall, a bottom wall, a back wall, a front wall and the end walls define left and right end walls. In some embodiments, the side walls comprise a side panel frame and a side panel and the end walls comprise an end panel frame and an end panel whereby edge joining elements and corner joining elements on the panel frames are configured to mate and couple the side panel frames with the end panel frames to define the enclosure area. In some embodiments, an extension frame is provided whereby the enclosure area may be extended with another set of side walls.

### CROSS-REFERENCE TO RELATED APPLICATIONS

This application claims benefit of U.S. Pat. App. No. 63/210,945 filed Jun. 15, 2021 and entitled “COLLAPSIBLE ENCLOSURE SYSTEM”.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### 1. Field of the Invention

This invention relates to enclosures for living creatures, in particular collapsible enclosure systems that allows the enclosure to be easily shipped and configured.

### BRIEF SUMMARY OF THE INVENTION

The following summary is included only to introduce some concepts discussed in the Detailed Description below. This summary is not comprehensive and is not intended to delineate the scope of protectable subject matter, which is set forth by the claims presented at the end.

A collapsible enclosure system to retain a living creature is provided comprising hinged frames and panels configured to be rapidly coupled to define an enclosure area to retain the living creature. Embodiments of the collapsible enclosure system are also able to be collapsed into a low profile that may enable more secure and less expensive shipping costs. The configuration of the enclosure system to be partially assembled makes assembly of the enclosure simpler. In addition, the joining elements and the way that the walls are coupled add to the ease of assembly.

In one example embodiment, a collapsible enclosure system to retain a living creature is provided comprising a plurality of enclosure walls, one or more of the plurality of enclosure walls being hingedly coupled, and the plurality of enclosure walls configured to couple whereby the enclosure system defines an enclosure area to retain a living creature.

In one example embodiment, a collapsible enclosure system to retain a living creature is provided comprising: a plurality of enclosure walls; the plurality of enclosure walls comprising a plurality of side walls and a plurality of end walls; the plurality of side walls being hingedly coupled whereby the side walls define a top wall, a bottom wall and a back wall; and the plurality of end walls and the plurality of side walls configured to couple whereby the enclosure system defines an enclosure area to retain a living creature.

In one example embodiment, a collapsible enclosure system configured to define an enclosure area to retain a living creature is provide comprising a plurality of side walls and a plurality of end walls, the plurality of side walls being hingedly coupled whereby the side walls define a middle side wall and a plurality of peripheral side walls and the plurality of end walls and the plurality of side walls configured to couple whereby the collapsible enclosure system defines an enclosure area to retain a living creature. In some of the embodiments, each of the plurality of side walls comprising a side panel frame and a side panel, the side panel frame comprising a plurality of side panel struts and a plurality of end edge struts and the side panel comprising a planar panel. In some of the embodiments, each of the plurality of end walls comprising an end panel frame and an end panel, the end panel frame comprises a plurality of end edge struts and the end panel comprising a planar panel. In some embodiments, a front wall comprises one or more door panel configured to couple with one or more of the plurality of side walls and provide the front wall to the collapsible enclosure system. In some embodiments, the side panel frame further comprises one or more hinge configured to hingedly couple the side panel of the middle side wall with the side panel frame of the plurality of peripheral side walls. In some embodiment, the side panel struts comprise a hinged edge strut and an unhinged edge strut, the middle side wall comprising a middle side panel frame comprising a plurality of the hinged edge struts and a plurality of the end edge struts, each of the peripheral side walls comprising a peripheral side panel frame comprising one of the hinged edge strut, one of the unhinged edge strut and a plurality of the end edge struts and the hinged edge strut further comprises one or more hinge configured to hingedly couple the hinged edge struts of the middle side wall and the hinged edge struts of the plurality of peripheral side walls. In some embodiments, the plurality of end edge struts of the end walls and the end edge struts of the side walls further comprises one or more edge joining element configured to mate one or more side panel frame with one or more end panel frame. In some embodiments, the edge joining element comprises a recess in the one of the plurality of end edge struts of the side panel frame that mates with a protrusion in the one of the plurality of end edge struts of the end panel frame. In some embodiments, the edge joining element comprises a rib and a mating channel, the rib extending on an exterior surface of one of the end edge struts of the end walls or one of the end edge struts of the side walls and the mating channel extending on the exterior surface of the other of the end edge struts of the end walls or the end edge struts of the side walls. In some embodiments, the end panel frame further comprises one or more corner joining element configured to mate the side panel frame with the end panel frame. In some embodiments, the corner joining element comprises a recess in one of the end panel frame or the side panel frame and a protrusion on the other of the end panel frame or the side panel frame whereby the protrusion mates with the recess to couple the plurality of end walls with the plurality of side walls. In some embodiments, the side panel frame further comprises one or more side corner joining element coupling one or more of the end edge struts of the side walls to one or more of the side panel struts of the side walls, the end panel frame further comprises one or more end corner joining element coupling the plurality of end edge struts of the end walls and the one or more side corner joining element configured to mate with the one or more end corner joining element whereby the plurality of end walls with the plurality of side walls are coupled. In some embodiments, the collapsible enclosure system further comprising an extension frame configured to couple with the side walls whereby the enclosure area is extended to define an extended enclosure area. In some embodiments, the collapsible enclosure system further comprises an extension frame, the plurality of side walls comprising a first set of side walls and a second set of side walls, the plurality of end walls comprising a first end wall and a second end wall, the first end wall configured to couple with the first set of side walls, the second end wall configured to couple with the second set of side walls and the extension frame configured to couple with the first set of side walls and the second set of side walls whereby the enclosure area is extended to define an extended enclosure area. In some embodiments, the extension frame further comprises one or more edge joining element and the one or more edge joining element of the extension frame configured to mate with one or more edge joining element on first set of side walls and with one or more edge joining element on the second set of side walls to couple the first set of side walls, the extension frame and the second set of side walls. In some embodiments, the extension frame further comprises one or more corner joining element and the one or more corner joining element of the extension frame configured to mate with one or more corner joining element on first set of side walls and with one or more corner joining element on the second set of side walls to couple the first set of side walls, the extension frame and the second set of side walls.

In one example embodiment, a collapsible enclosure system configured to define an enclosure frame for an enclosure area to retain a living creature is provided comprising an extension frame, a plurality of wall frames, one or more of the plurality of wall frames being hingedly coupled to another of the wall frames and the plurality of wall frames and the extension frame configured to couple whereby the collapsible enclosure system defines an extended frame for an enclosure area to retain a living creature. In some embodiment, the plurality of wall frames comprise a plurality of side panel frames comprising a plurality of hinged edge struts and a plurality of end edge struts. In some embodiment, the plurality of wall frames further comprise a plurality of end panel frames comprising a plurality of end edge struts. In some embodiments, the plurality of end panel frames further comprise one or more edge joining element configured to mate one of the plurality of the end panel frames with one of the plurality of the side panel frames. In some embodiments, the plurality of end panel frames further comprise one or more corner joining element configured to mate one of the plurality of end panel frames with one of the plurality of the side panel frames. In some embodiments, the collapsible enclosure system further comprises an extension frame, the plurality of side panel frames comprising a first set of side panel frames and a second set of side panel frames, the plurality of end panel frames comprising a first end panel frame and a second end panel frame, the first end panel frame configured to couple with the first set of side panel frames, the second end panel frame configured to couple with the second set of side panel frames and the extension frame configured to couple with the first set of side panel frames and the second set of side panel frames whereby the enclosure frame for the enclosure area is extended.

In one example embodiment, a method of configuring a collapsible enclosure system to retain a living creature is provided, the method comprising providing a collapsible enclosure system comprising: a plurality of side walls and a plurality of end walls, the plurality of side walls being hingedly coupled whereby the side walls define a middle side wall and a plurality of peripheral side walls, and the plurality of end walls and the plurality of side walls configured to couple whereby the collapsible enclosure system defines an enclosure area to retain a living creature; extending the plurality of side walls whereby the middle wall defines a back wall of the enclosure area, one of the plurality of peripheral side walls defines a top wall of the enclosure area and another of the plurality of peripheral side walls defines a bottom wall of the enclosure area; and coupling the plurality of end walls to the plurality of side walls to define two end walls of the enclosure area. In some embodiments, the plurality of end walls to the side walls to define two side walls of the enclosure area comprises mating one or more edge joining element of the end walls with one or more edge joining element of a the side walls. In some embodiments, coupling the plurality of end walls to the side walls to define two side walls of the enclosure area comprises mating one or more corner joining element of the end walls with one or more corner joining element of the side walls.

Other objects, features, and advantages of the techniques disclosed in this specification will become more apparent from the following detailed description of embodiments in conjunction with the accompanying drawings.

### BRIEF DESCRIPTION OF THE SEVERAL VIEWS OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows an illustrative diagram of an example embodiment of a collapsible enclosure system without the top side panel;

FIGS. 2A-2D show an example embodiment of side walls of an assembled collapsible enclosure system with FIG. 2A showing a top view, FIG. 2B showing a back view, FIG. 2C showing a bottom view and FIG. 2D showing a front view;

FIGS. 3A-3C show an example embodiment of an expanded collapsible enclosure system with FIG. 3A showing a back view, FIG. 3B showing a side view of the middle and peripheral side walls and FIG. 3C showing a perspective view of the middle and peripheral side walls hingedly coupled to each other;

FIG. 3D shows and example embodiment of a hinge;

FIGS. 4A-4F show different views of an example embodiment of a collapsible enclosure system expanded to show the side walls and end walls with FIG. 4A showing a perspective view, FIG. 4B showing a side view, FIG. 4C showing a perspective view, FIG. 4D showing a side view, FIG. 4E showing a front view and FIG. 4F showing a perspective view of the collapsible enclosure system partially folded;

FIGS. 5A-5B show an example embodiment of an end wall coupled to the end edge of side walls with FIG. 5B showing the end wall and FIG. 5A showing details of end edge struts;

FIGS. 6A-6G show example embodiments of the edge joining elements with FIG. 6A showing edge joining element details, FIG. 6B showing corner joining element details, FIG. 6C showing a corner joining element, FIG. 6D showing edge joining element details, FIG. 6E showing a corner joining element, FIG. 6F showing corner joining element details and FIG. 6G showing corner joining element details;

FIGS. 7A-7C show different views of a side wall partially exploded to show a corner joining element with FIG. 7A showing an outside perspective view, FIG. 7B showing a side view and FIG. 7C showing an inside perspective view;

FIGS. 8A-8C show different inside views of a side wall partially exploded with FIG. 8A showing details of an edge and corner joining element, FIG. 8B showing details of an edge joining element and FIG. 8C showing a partially exploded view to show the corner joining element, edge joining elements and the vertical door channels;

FIGS. 9A-9C show different views of an end wall partially exploded with FIG. 9A showing an outside view of the end wall, FIG. 9B showing a side view and FIG. 9C showing an inside view of the end wall showing the vertical door channels;

FIGS. 10A-10E show different views of end panel frame elements with FIG. 10A showing edge joining element details, FIG. 10B showing corner joining element details, FIG. 10C showing edge and corner joining element details, FIG. 10D showing an exploded corner joining element with edge and corner joining element details and FIG. 10E showing an exploded corner joining element with edge and corner joining element details and vertical door channels; and

FIGS. 11A-11E show different views of an example embodiment of an extension frame with FIG. 11A showing a perspective view, FIG. 11B showing a front view, FIG. 11C showing a side view, FIG. 11D showing a top view and FIG. 11E showing a bottom view.

### DETAILED DESCRIPTION OF THE INVENTION

COPYRIGHT NOTICE: A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to any software and data as described below and in the drawings hereto: Copyright © 2021-2022, Zen Habitats Inc., All Rights Reserved.

Collapsible enclosure systems and methods of use will now be described in detail with reference to the accompanying drawings. It will be appreciated that, while the following description focuses on a system that provides enclosure for animals, the systems and methods disclosed herein have wide applicability. Notwithstanding the specific example embodiments set forth below, all such variations and modifications that would be envisioned by one of ordinary skill in the art are intended to fall within the scope of this disclosure.

### One Example Embodiment of the Collapsible Enclosure System

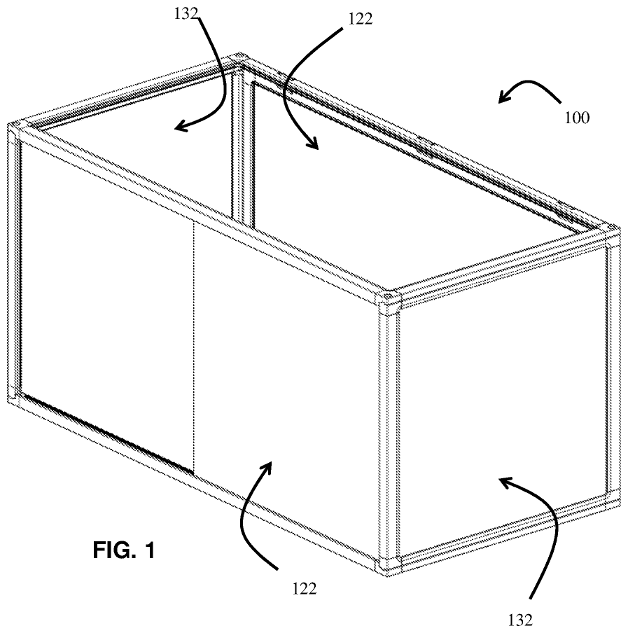

For illustration purposes and not for limitation, one example embodiment of the collapsible enclosure system is shown in FIG. 1. As shown in FIG. 1, the collapsible enclosure system 100 generally comprises a plurality of enclosure walls coupled to create an enclosure for a creature such as a pet animal. As shown, the enclosure walls comprise multiple side walls 122 and multiple end walls 132. For illustration purposes, FIG. 1 shows one of the enclosure walls (here the top side wall) without a side panel and a front side wall comprising a door panel.

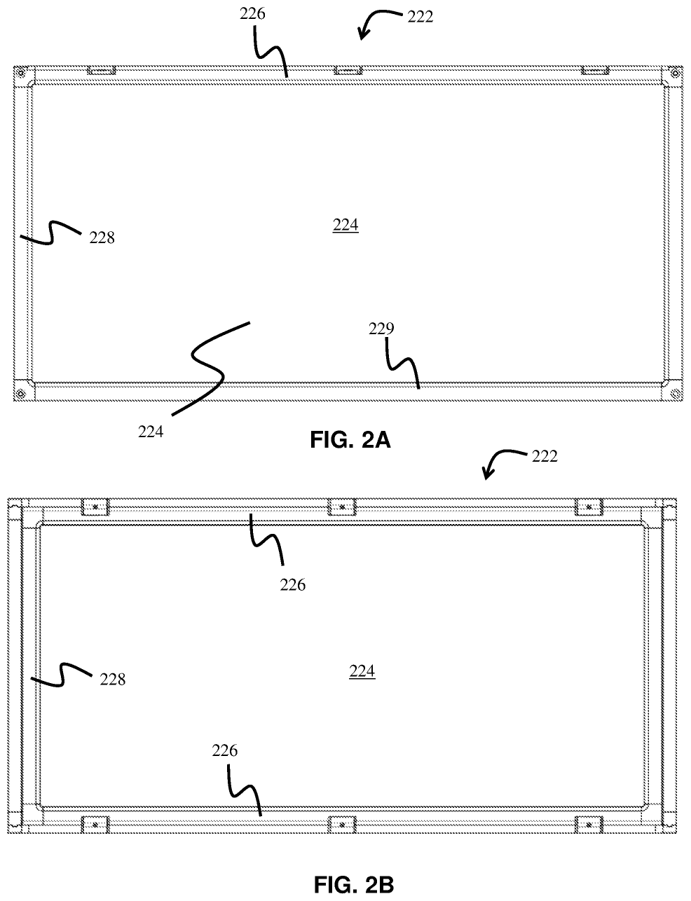

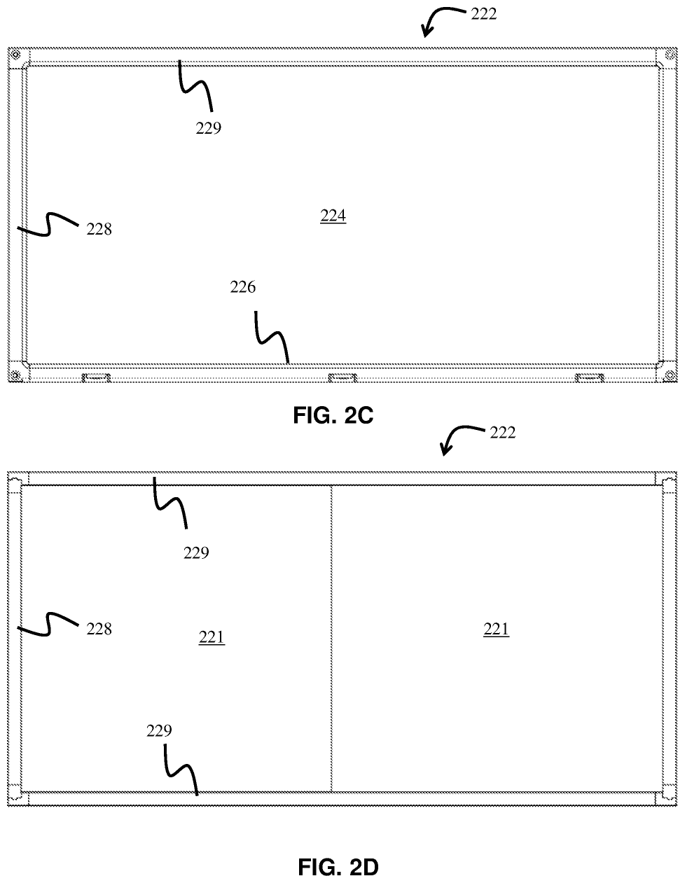

As shown in FIGS. 2A-2D, the side walls 222 each generally comprise a side panel 224 and side panel frame. The side panel frame generally comprises struts to couple the side walls and retain the panel 224. The side walls may define a middle wall and two peripheral walls to define three sides of the enclosure. As shown in FIG. 2A, an example of side panel frame of the peripheral wall comprises end edge struts 228, hinged edge strut 226 and unhinged edge strut 229. The side panel 224 is generally a planar panel and is coupled to the side panel frame. As shown in FIG. 2B, an example embodiment of a side panel frame of the middle wall comprises end edge struts 228 and hinged edge struts 226. Shown in FIG. 2C is another side panel frame of a peripheral wall comprising end edge struts 228, hinged edge strut 226 and unhinged edge strut 229. The hinged edge struts 226 of the peripheral walls are generally coupled to the hinged edge struts 226 of the middle wall. FIG. 2D shows one of the side walls comprising door panels 221 coupled to the unhinged edge struts 229.

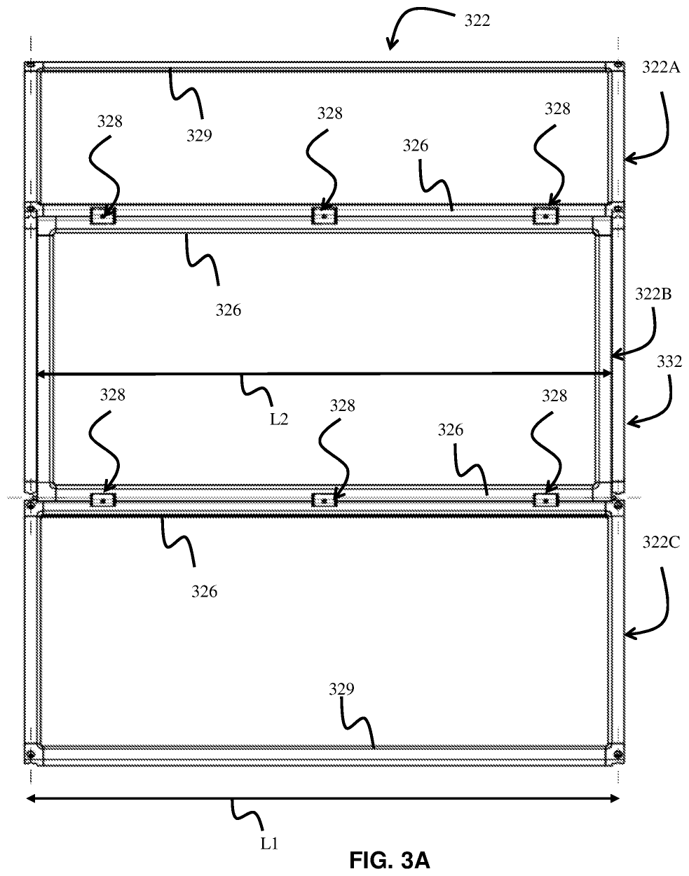

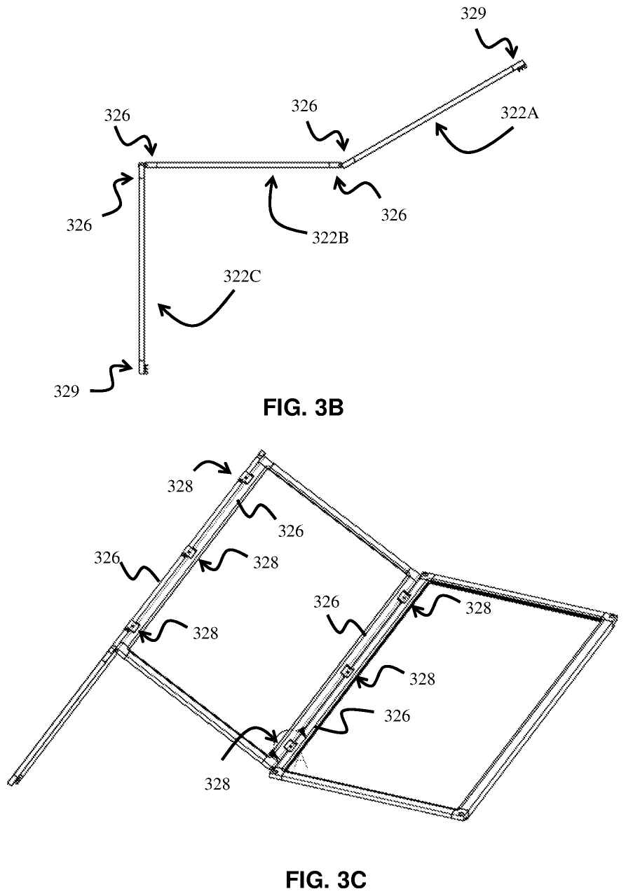

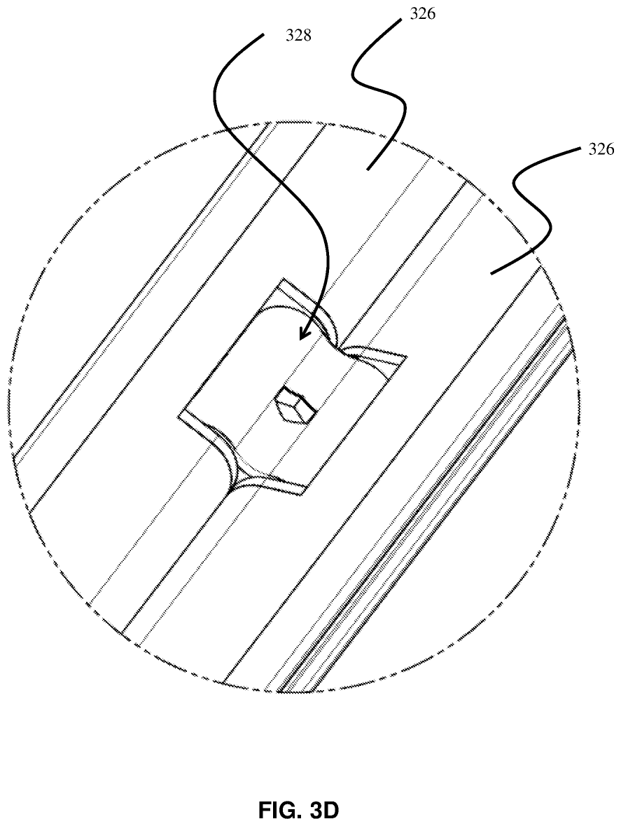

As shown in FIG. 3A, the side walls 322A-322C are hingedly coupled with hinged edge struts 326 whereby the side walls define the middle wall 322B and two peripheral walls 322A and 322C. In embodiments, the middle wall 322B may define a back wall of the enclosure and the two peripheral walls 322A and 322C may define a top and bottom wall of the enclosure. The hinged coupling may be done with hinges 328 on hinged edge struts 326 as shown. The end walls 332 and the plurality of side walls 322 are configured to couple whereby the enclosure systems defines an enclosure area to retain a living creature. In some embodiments, the side walls may have different dimensions to accommodate coupling with other elements. For example, as shown, the length of the peripheral walls 322A and 322C have a longer length L1 as compared to length L2 of the middle wall 322B whereby the peripheral walls overlap a portion of the end wall 332. This overlap allows a portion of the frame of peripheral walls 322A and 322C to couple with a portion of the frame of the end wall 332 and securely couple the side and end walls together. Some embodiments may also include a front wall or door wall (not shown) or the front wall or door wall may be coupled to the unhinged edge struts 329 of the peripheral walls 322A and 322C defining a top and bottom wall respectively. It is understood that reference to the positioning of walls as top, bottom, back or front is for illustration purposes only and any side walls of the enclosure system may function as the top, bottom, back or front wall.

Referring to FIG. 3C, the hinged coupling of two hinged edge struts 326, the plurality of hinged edge struts 326 further comprise one or more hinge 328 configured to hingedly couple the hinged edge struts 326.

FIG. 3D shows a close-up view of a hinge 328 and two hinged edge struts 326 consistent with the embodiment shown in FIGS. 3A-3C. The hinge may allow for any degree of rotation of the edge struts relative to each other to include a 360-degree rotation (see side view in FIG. 3B).

Some embodiments may have the front wall or door wall coupled to the struts, for example the unhinged edge struts, of the top wall and the bottom wall. This coupling may be made by door panels that are separate but couple with coupling elements in one or more of the side panels or struts of the side panels. For example, the door panels may be sized and configured to securely fit into a slide channel on the inside surface of edge struts of one or more of the side panels, or the door panels may couple to a hinge coupling on a strut, such as a hole on the door panel and side panel to receive a pin, coupled to the door panel. In some of these embodiments, the edge struts of the end walls may also have features that accommodate door panels. For example, some end edge struts of the end wall may have a recess or channel to receive ends of the door panels when the door is shut.

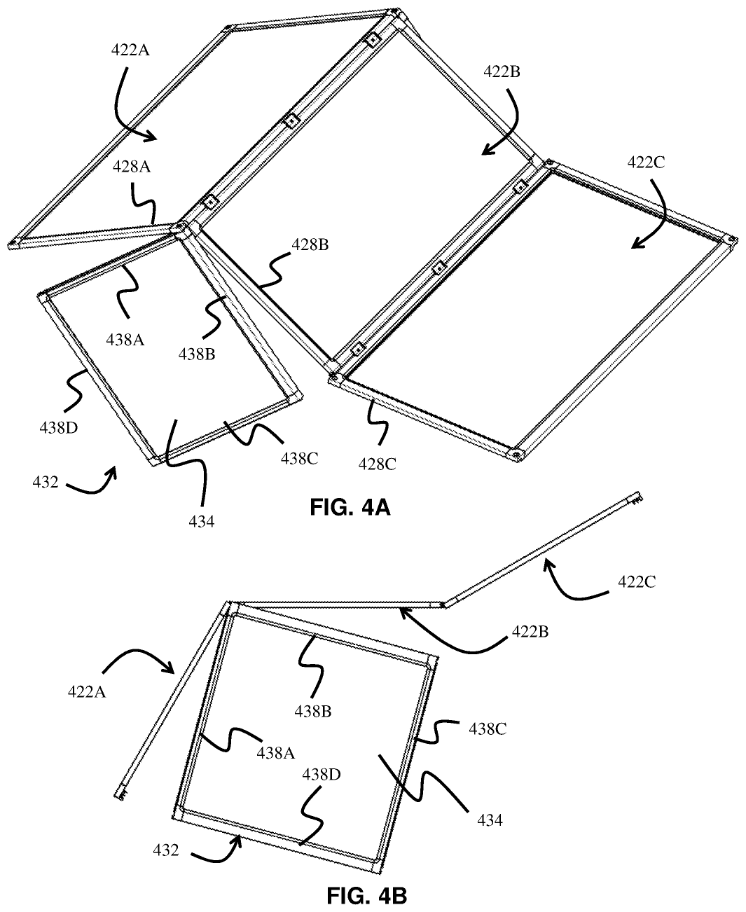

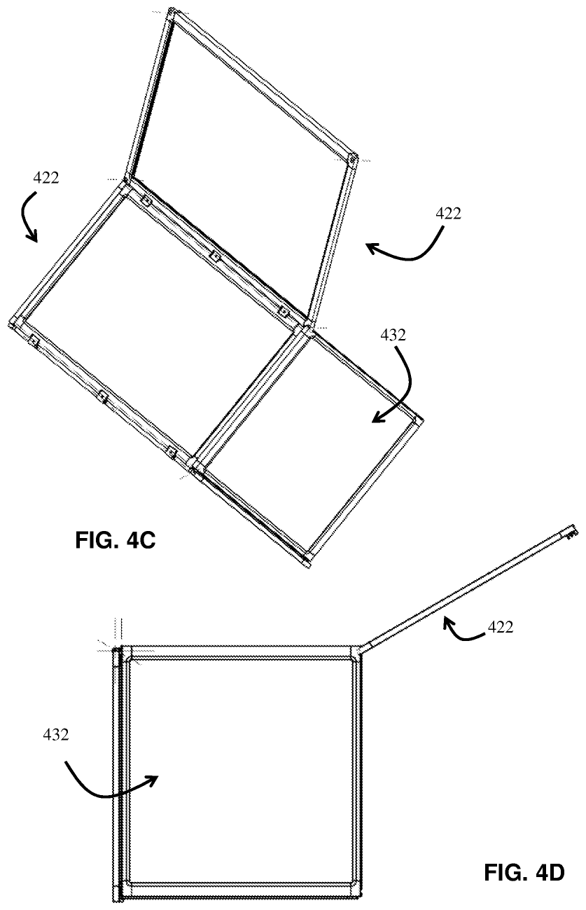

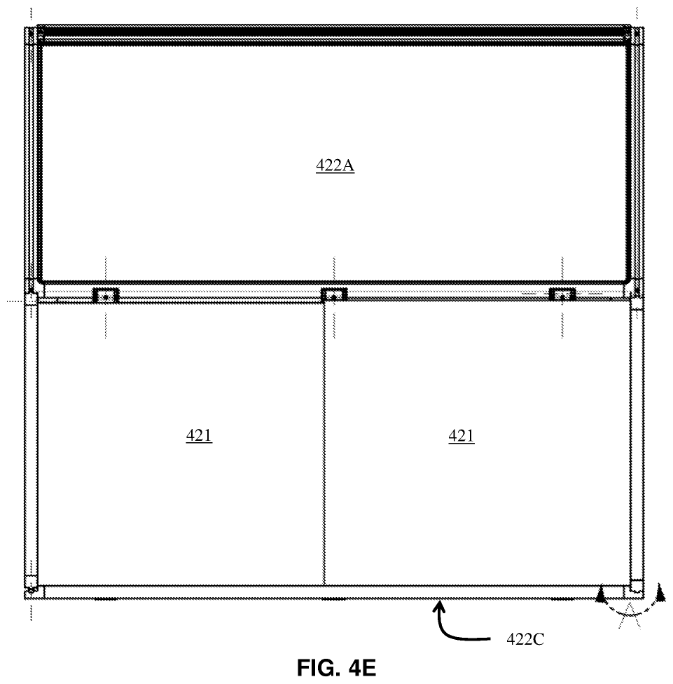

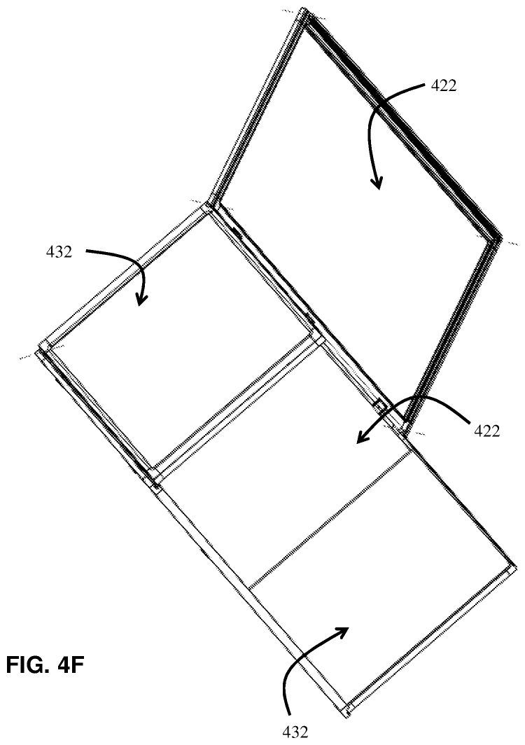

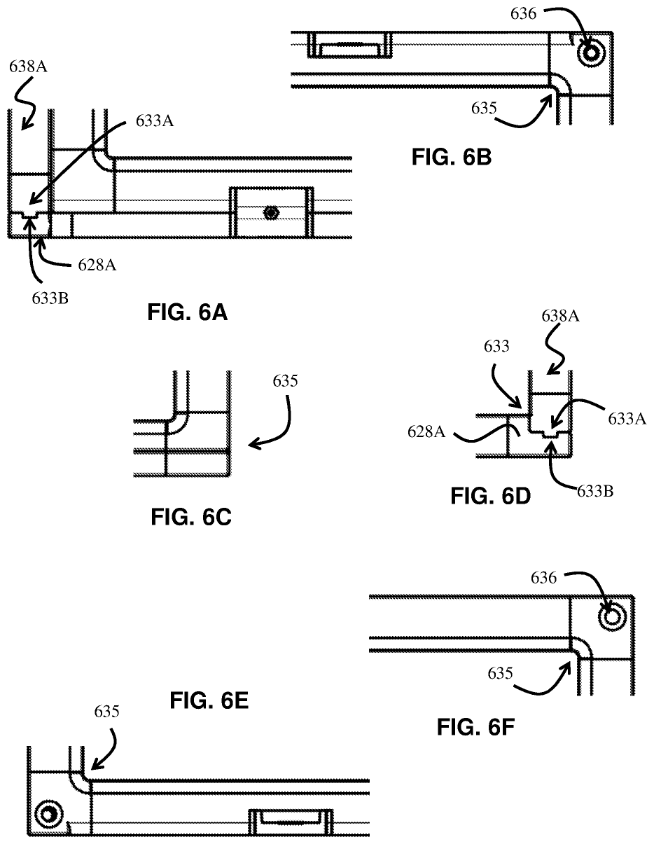

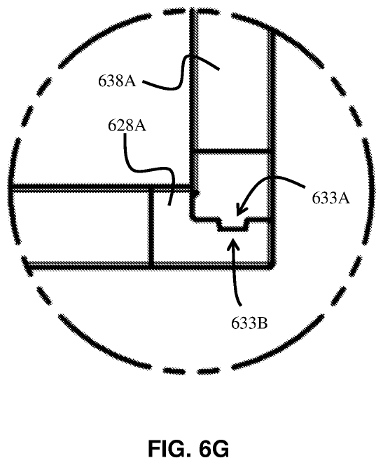

FIGS. 4A-4F illustrate the coupling of the side walls with the end walls. Referring to FIGS. 4A and 4B, each of the plurality of end walls 432 comprises an end panel frame and an end panel 434 with the end panel frame comprising a plurality of end edge struts 438A-438D and the end panel 434 generally further comprising a planar panel. As shown, the end edge strut 428A and 428C of the side walls 422A and 422C are configured to overlap the end edge struts 438A and 438C of the end wall 432 and the end edge strut 438B is configured to overlap the end edge strut 428B of the side/back wall 422B. In the embodiment shown, the end edge struts 438A-428C are configured to abut and mate with the end edge struts 428A-428C of the side walls 422A-422C. FIGS. 4C-4F show different views of side walls 422 and end walls 432 at varying stages of being collapsed. With this configuration, an edge joining element is positioned generally on the inside edge of the end edge struts 428A and 428C of the side panel frame and a mating edge joining element is positioned on the outside edge of the end edge struts 438A and 438C of the end panel frame (see FIG. 6G). In some embodiments, the rigidity of the end and side panel frames permit one or more of the end edge struts to secure the corner of the enclosure area without having to have an edge joining element. In some embodiments, an edge joining element may also be positioned generally on the inside edge of the end edge strut 438B of the end panel frame to mate with a mating edge joining element on the outside edge of the end edge strut 428B of the side panel frame.

Although the referenced drawings show the side walls hingedly coupled, it is contemplated that some embodiments may have other walls hingedly coupled. In some embodiments, any of the panel walls may be hingedly coupled and the other walls are coupled to the other walls. For example only, and not for limitation, one or more of the end walls may be hingedly coupled to a side wall and the other side walls may couple to those walls. For example, FIG. 4F shows on of the end walls 432 folded on top of one of the side walls 422 and the other end wall 432 extended. This folding may be hinged for ease or configuring or this folding may be unhinged and used to make a smaller system profile for shipping.

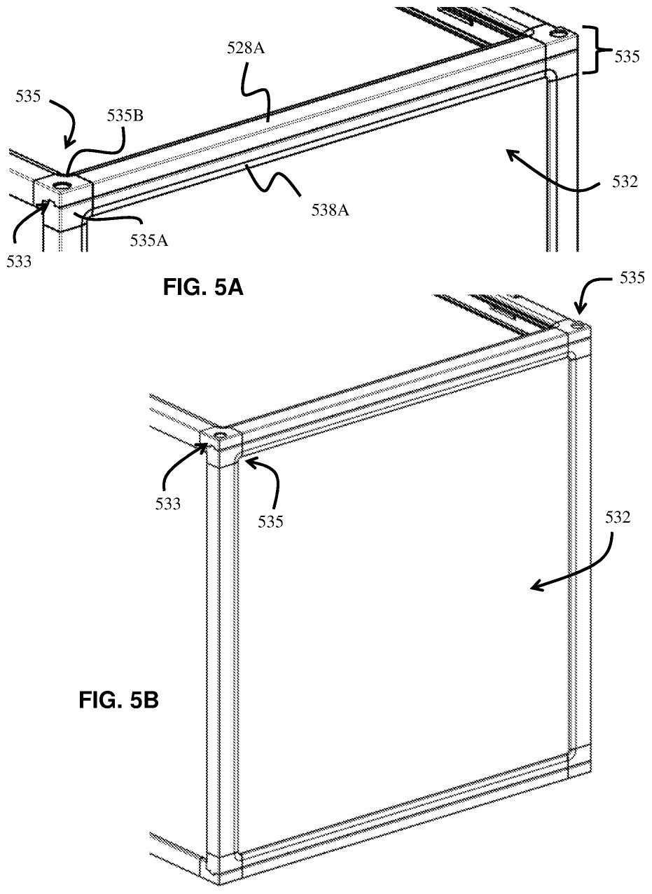

Referring to FIGS. 5A and 5B, some of the plurality of end edge struts may further include one or more edge joining element to couple end edge struts. The edge joining element may be any element configured to couple the end edge struts of the end walls with the end edge struts of the side walls. For example and not for limitation, the edge joining element may be a mated fitting of protrusions and recesses, an adhesive coupling, clips or screws. FIG. 5B shows an example embodiment of an end wall 532 coupled to the end edge of side walls with edge joining elements 533. Referring to FIG. 5A, the edge joining element 533 is configured to mate the end edge strut 538A of the side wall with the end edge strut 528A of the end wall 532. The edge joining element may be any element to couple the end edge struts of the side walls and end walls. For example, as shown, the edge joining element may be a recess in one of the struts that mates with a protrusion of the other panel. FIGS. 6D-6G also show an embodiment of the edge joining elements (see 633, 633A and 633B) consistent with FIGS. 5A and 5B.

Referring to FIGS. 5A and 5B, some of the plurality of end edge struts may further includes one or more corner joining element 535 configured to mate the corners of the end edge struts of the side walls with the end edge struts of the end wall 532. The corner joining element may be any element configured to couple the end edge struts of the end walls with the end edge struts of the side walls at or proximal to a corner of the frame. For example and not for limitation, the edge joining element may be a mated fitting of protrusions and recesses, an adhesive coupling, clips or screws. FIG. 5B shows an example embodiment of an end wall 532 coupled to the end edge of side walls with corner joining elements 535. Referring to FIG. 5A, the corner joining element 535 may comprises a side panel corner joining element 535B and an end panel corner joining element 535A configured to mate the corner of the end edge strut of the side panel with the corner of the end edge strut of the end panel. As shown, the corner joining element 535 may also comprise a recess in one or more of the corner of the end edge strut of the side and/or end panel to allow a coupler, such as a screw, to join the corners. FIGS. 6B, 6E and 6F also show an embodiment of the corner joining element consistent with FIGS. 5A and 5B.

Although the described embodiments couple the side walls and the end walls through an overlapping of walls and frame components and use of edge and corner joining elements, it is understood that any coupling means may be used to couple the side walls and the end walls. For example and not for limitation, the end walls and side walls may not overlap and may be coupled simply with edge joining elements or corner joining elements. For example, corner joining element may comprise recesses in the edge struts or corners of the end walls and side walls and a screw or pin to go through and couple the walls. In some embodiments, the end walls and side walls may be rigidly coupled with an adhesive or other coupling element.

FIGS. 6A-6G show example embodiments of a coupling of side walls and end walls. As shown in FIG. 6A, the side walls may couple with the end wall by having the end edge strut 628A of the side wall overlap the end edge strut 638A of the end wall. FIG. 6B shows corner joining element 635 and recess or hole 636. FIG. 6C shows corner joining element 635. FIG. 6D shows details of edge joining element 633 including protrusion 633A on end edge strut 638A and channel 633B on the side wall end edge strut 628A. FIG. 6E shows corner joining element 635. FIG. 6F shows corner joining element 635 and recess or hole 636. FIGS. 6A-6G illustrate how some embodiments of the peripheral side panels (e.g., top side and bottom side panels) are coupled to end panels. In these embodiments, the edge joining elements and corner joining elements help couple the side walls and the end walls. As shown in FIGS. 6A, 6D and 6G, the coupling of the side wall and the end wall may be made with edge joining element 633 such as a protrusion 633A in the end edge strut 638A mating with a channel 633B of the side wall end edge strut 628A. This edge coupling helps secure the edges of the enclosure to each other. Consistent with FIGS. 6B, 6C, 6E and 6F, the corner joining elements 635 may be used to further secure the coupling of the side walls and the end walls. The corner joining element 635 may comprise an end wall corner joining element and a side wall corner joining element. The corner joining elements may be any elements to couple the corners of the end walls with the side walls. In some embodiments, consistent with FIGS. 6B, 6E and 6F, the corner joining elements 635 may comprise a recess or hole 636 in the corner joining element 635 of the end edge struts of the end wall and the side that will receive a coupler, such as a screw, to secure the end wall to the side walls. These recesses 636 and use of an element such as a mated screw to fit in these recesses can more rigidly couple the corners. By using these features of the corner joining element 635 the side walls are more rigidly coupled with the end walls at the corner. And with rigid or semi-rigid struts, the corner joining elements 635 help couple the edge joining elements and helps rigidly couple the frame of the enclosure. In some embodiments, the corner joining elements 635 may be used in only some of the side walls such as in the peripheral side walls (e.g., top and the bottom side wall).

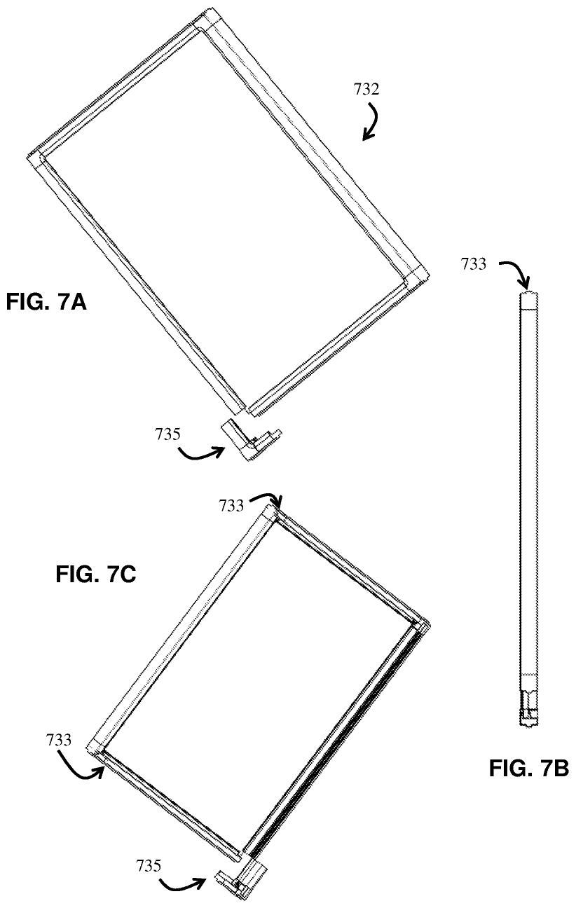

FIGS. 7A-7C show different views of an end wall with some components of the side panel frame exploded. FIG. 7A shows a view of an end wall 732 showing the outside view with the corner joining element exploded. FIG. 7B shows a side view of the end wall showing edge joining elements 733. FIG. 7C shows an inside view of the end wall showing an example embodiment of a corner joining element 735 that is configured to be received into a generally hollow of the end edge strut and an example embodiment of an edge joining element 733 on the outside edge of the end wall frame.

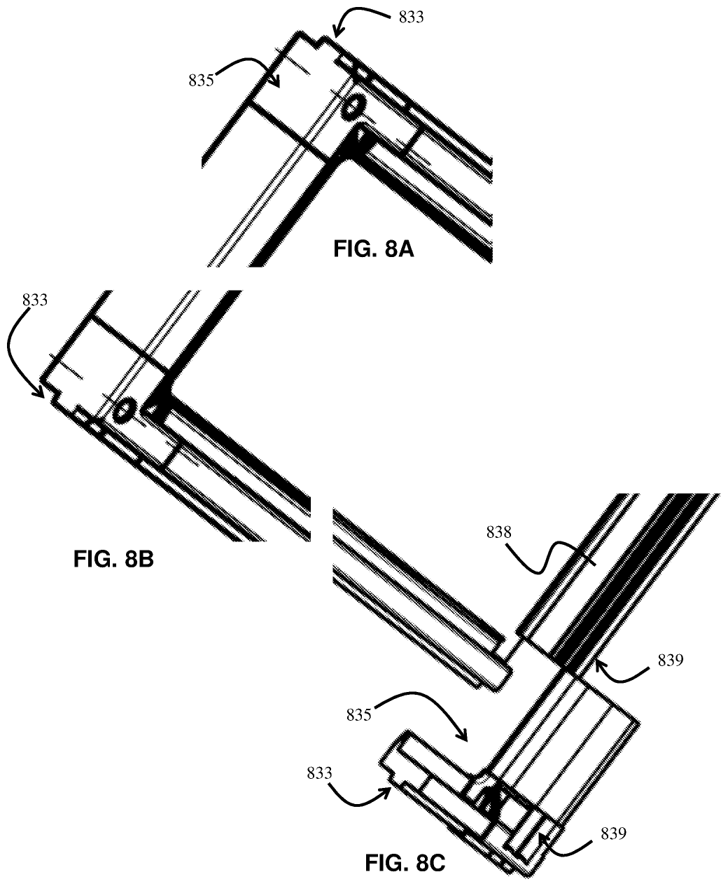

FIGS. 8A-8C show different portions of an inside view of an end wall frame with some components of the side panel frame exploded. Shown is an example embodiment of a exposed corner joining element 835 that is received into a generally hollow of the end edge strut. Also shown is an example embodiment of an edge joining element 833 on the outside edge of the end wall frame. Also shown is an example embodiment of vertical door channels 839 on end edge strut 838.

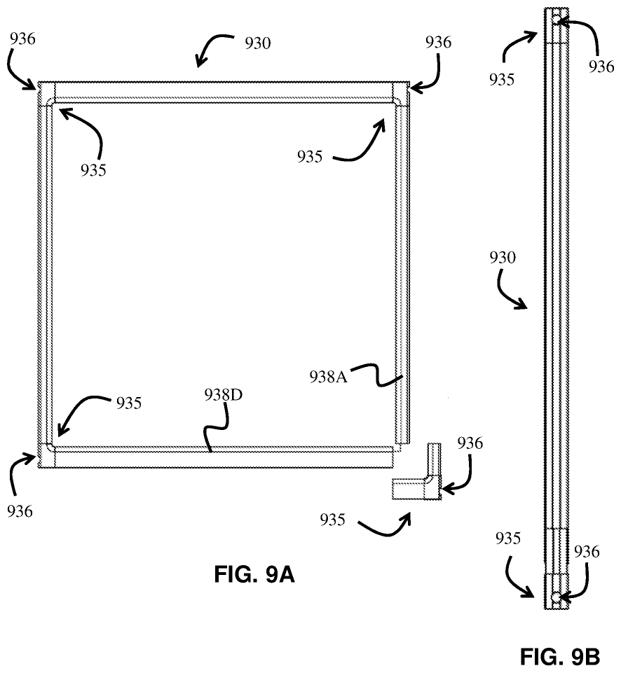

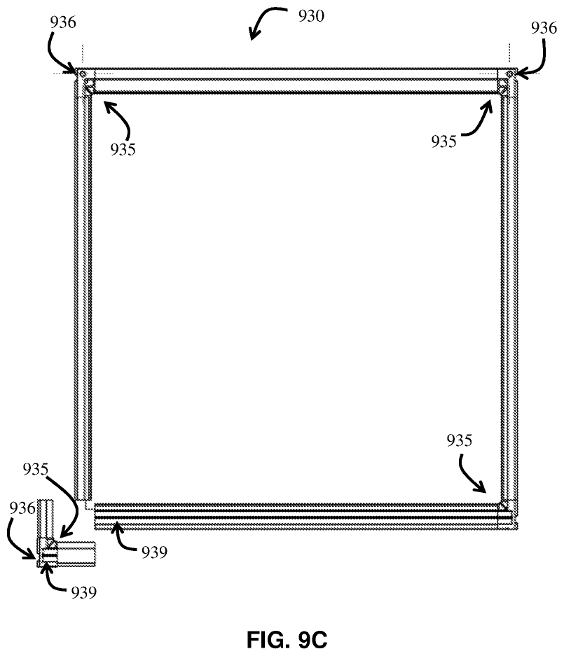

FIGS. 9A-9B show different views of an end wall frame with some components of the end panel frame exploded. FIG. 9A shows an example embodiment of an end panel frame 930 with of corner joining elements 935 that are configured to be received into a generally hollow of the end edge struts 938A and 938D. Also shown is an example embodiment of. FIG. 9B shows a side view of the end panel frame 930 and FIG. 9C showing an inside view of the end wall frame showing a position of a recess 936 in the corner joining element 935 and an example embodiment of vertical door channels 939.

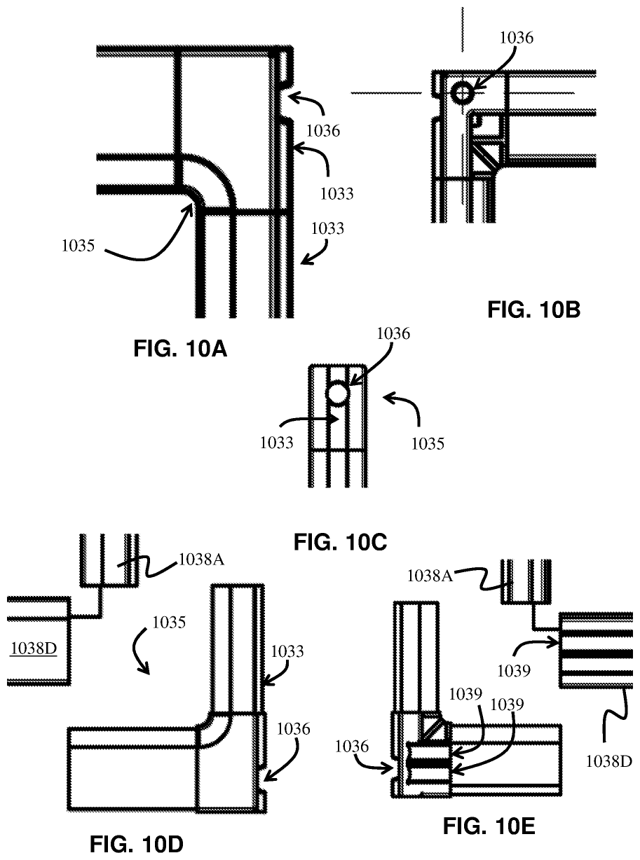

FIGS. 10A-10E show different views of end panel frame elements to include edge joining element 1033 details and corner joining element 1035 details. FIG. 10A shows edge joining element 1033 on the outside exterior surface of the end wall frame and corner joining element 1035 details including the recess or hole 1036. FIG. 10B shows a view of the recess or hole 1036. FIG. 10C shows a top view of corner joining element 1035, edge joining element 1033 and recess or hole 1036. FIG. 10D shows an exploded corner joining element 1035 also showing edge joining element 1033 and recess or hole 1036. As shown, the corner joining element 1035 is received into a generally hollow of the end edge struts 1038A and 1038D. FIG. 10E shows an exploded corner joining element for coupling with end edge struts 1038A and 1038D with edge and corner joining element details and vertical door channels 1039 on the inside of the end panel frame.

### Example Embodiments of the Collapsible Enclosure Systems with Extension Components

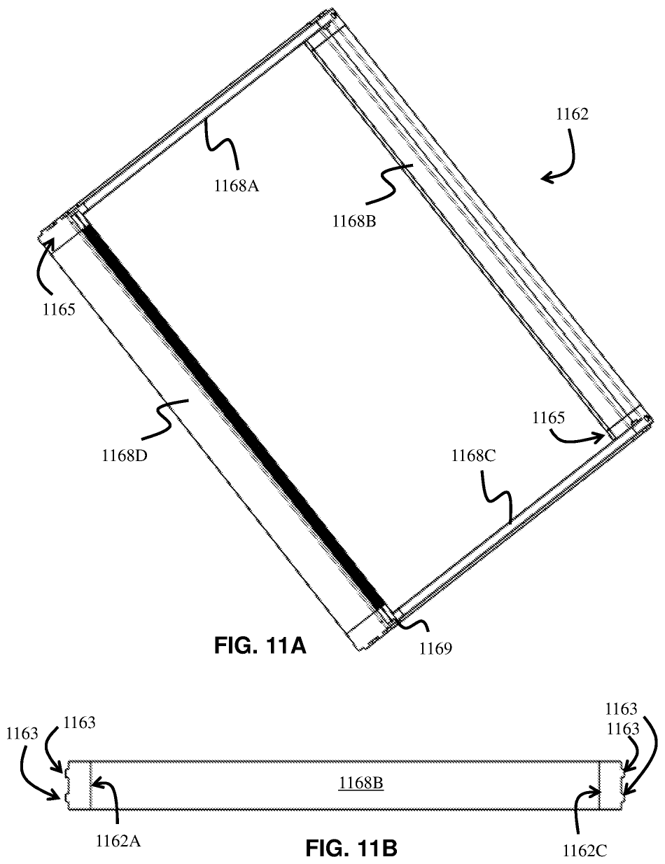

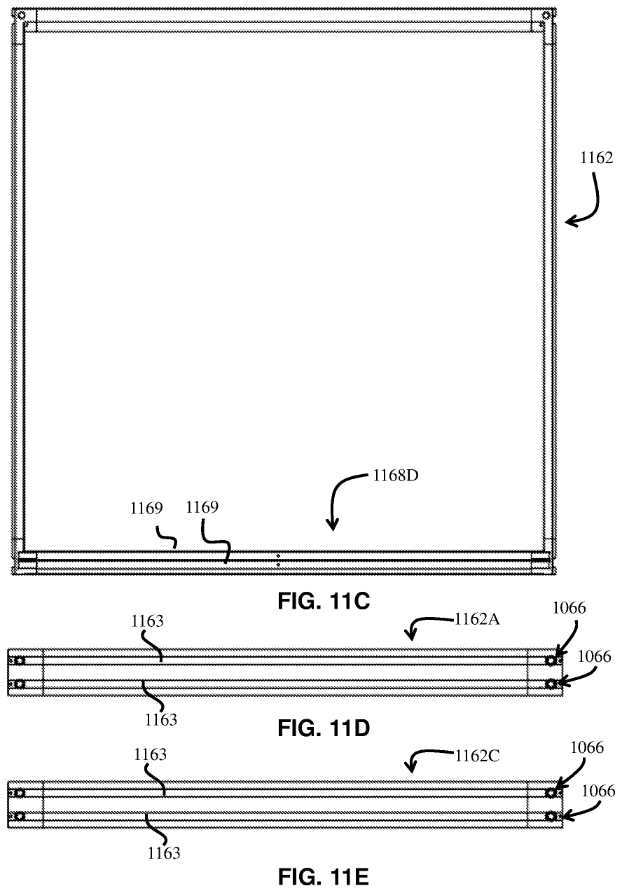

As shown in FIGS. 11A-11E, some embodiment of the collapsible enclosure system may further comprise extension components. As shown in FIG. 11A, similar to the end wall and the end panel frame, the extension frame 1162 may comprise multiple extension edge struts 1168A-1168D coupled with corner joining elements. The extension edge struts 1168A-1168D may comprise struts configured to couple with end edge struts of the side walls. For example, extension edge struts 1168A and 1168C may couple with the side wall frame with edge joining elements 1163 or corner joining elements 1165. Extension edge struts 1168B and 1168D may couple with the side wall frame through the use of edge joining elements, corner joining elements or may couple to the side walls through their rigid coupling to other extension frame elements. Different than the end edge frame described above, the extension frame 1162 may accommodate coupling of multiple side walls with a single frame. As shown in FIG. 11B, this is reflected by the multiple edge joining elements 1163 on extension edge struts 1168A and 1168B. FIG. 11C shows an example embodiment of vertical door channels 1169 that may be positioned on both sides of the extension edge strut 1168D. As shown in FIGS. 11D and 11E, in some embodiments, another difference is reflected in in the use of one or more additional corner joining element and one or more additional recess 1066 to accommodate corner joining element components.

### One Embodiment of the Collapsible Enclosure System in Operation

Operation of one embodiment of the collapsible enclosure system generally comprises the steps of assembling the frame of the enclosure and assembling the extension assembly.

For purposes of illustrating the operation of one embodiment of a collapsible enclosure system, and not for limitation, the operation of an enclosure system similar to the embodiment shown in FIG. 1 is described. Although the embodiment described starts with the frames assembled, it is understood that some embodiments may have the frames unassembled and the struts, corner joining elements and hinges may need to be assembled.

Referring to FIGS. 3A-3C and 4A-4F, the process starts with the sidewall frame assembled and with the side walls already being hingedly coupled.

As shown in FIG. 3A, the peripheral wall 322A, the middle wall 322B and the peripheral wall 322C may be hingedly coupled. The walls are unfolded and expanded as in FIGS. 3B and 3C.

Referring to FIGS. 4A and 4B, with the end panel frames assembled, the end edge struts (e.g., 438A and 438C) of the end walls 432 are then matched with the end edge struts (e.g., 428A and 428C) of the side walls (e.g., 422A and 422C) so that the edge joining elements can couple the end walls to the side walls. The end walls are coupled when the side walls are unfolded to form the top, back and bottom walls of the enclosure. In some embodiments, the coupling of the end walls to the side walls to define two side walls of the enclosure area comprises mating one or more edge joining element of the end panel frames with one or more edge joining element of the side panel frames. In some embodiments, the coupling the end walls to the side walls to define two side walls of the enclosure area comprises mating one or more corner joining element of the end panel frames with one or more corner joining element of the side panel frames.

Referring to FIG. 4E, for embodiments with a door panel 421 (see FIGS. 1 and 4A), the door panel is positioned between the unhinged edge struts of the peripheral side wall 422A and the peripheral side wall 422C to secure the door panel between the two unhinged edge struts. The door panel 421 may be sized to be secured in horizontal channels in the inside of the unhinged edge struts of the peripheral walls to slide horizontally. The the door panel 421 may be a hinged door panel to have a pin or other hinge mechanism mated with the wall side edge struts to let the door panel 421 swing open.

Referring to FIGS. 5A and 5B, for embodiments with corner joining elements 535, the corner joining elements are used to further couple the end walls 532 to the side walls. For example, screws can be used with the corner joining elements to more rigidly couple the end walls 532 to the side walls. As described above, with the screws in place, the corner joiners screw the end walls and the side walls including the door.

For embodiments with an extension frame and a second set of side walls, one of the end walls is uncoupled or not coupled to the first set of side walls. In that end wall's place with respect to the first set of side walls, the extension frame is coupled to those side walls using the edge joining elements. To the extension frame, the second set of side walls are coupled to the exposed edge and corner joining elements of the extension frame. The end wall that was not coupled to the first set of side walls is then coupled to the open end of the second set of side walls to define an end of the enclosure. Door panels may also be secured to the second set of side walls to define a door to the enclosure.

It is understood that although this described example embodiment has the side wall, end wall and extension frame already assembled, it is possible to have the system configured to start operation with the struts, corner joiners and hinges not yet assembled. In those embodiments, assembly would start with assembling the frames by coupling the corner joining elements with the struts (e.g., inserting one into the other) to form the frames. The panels may be inserted into the frame during this assembly.

Although this invention has been described in the above forms with a certain degree of particularity, it is understood that the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention which is defined in the claims and their equivalents.

We claim:

1. A collapsible enclosure system configured to define an enclosure area to retain a living creature, the collapsible enclosure system comprising:
a plurality of side walls and a plurality of end walls;
the plurality of side walls being hingedly coupled whereby the side walls define a middle side wall and a plurality of peripheral side walls; and
the plurality of end walls and the plurality of side walls configured to couple whereby the collapsible enclosure system defines an enclosure area to retain a living creature.

2. The collapsible enclosure system of claim 1 wherein:
each of the plurality of side walls comprising a side panel frame and a side panel;
the side panel frame comprising a plurality of side panel struts and a plurality of end edge struts; and
the side panel comprising a planar panel.

3. The collapsible enclosure system of claim 2 wherein:
each of the plurality of end walls comprising an end panel frame and an end panel;
the end panel frame comprises a plurality of end edge struts; and
the end panel comprising a planar panel.

4. The collapsible enclosure system of claim 3 wherein a front wall comprises one or more door panel configured to couple with one or more of the plurality of side walls and provide the front wall to the collapsible enclosure system.

5. The collapsible enclosure system of claim 3 wherein the side panel frame further comprises one or more hinge configured to hingedly couple the side panel of the middle side wall with the side panel frame of the plurality of peripheral side walls.

6. The collapsible enclosure system of claim 3 wherein:
the side panel struts comprise a hinged edge strut and an unhinged edge strut;
the middle side wall comprising a middle side panel frame comprising a plurality of the hinged edge struts and a plurality of the end edge struts;
each of the peripheral side walls comprising a peripheral side panel frame comprising one of the hinged edge strut, one of the unhinged edge strut and a plurality of the end edge struts; and
the hinged edge strut further comprises one or more hinge configured to hingedly couple
the hinged edge struts of the middle side wall and the hinged edge struts of the plurality of peripheral side walls.

7. The collapsible enclosure system of claim 3 wherein the plurality of end edge struts of the end walls and the end edge struts of the side walls further comprises one or more edge joining element configured to mate one or more side panel frame with one or more end panel frame.

8. The collapsible enclosure system of claim 7 wherein the edge joining element comprises a recess in the one of the plurality of end edge struts of the side panel frame that mates with a protrusion in the one of the plurality of end edge struts of the end panel frame.

9. The collapsible enclosure system of claim 7 wherein the edge joining element comprises:
a rib and a mating channel;
the rib extending on an exterior surface of one of the end edge struts of the end walls or one of the end edge struts of the side walls; and
the mating channel extending on the exterior surface of the other of the end edge struts of the end walls or the end edge struts of the side walls.

10. The collapsible enclosure system of claim 3 wherein the end panel frame further comprises one or more corner joining element configured to mate the side panel frame with the end panel frame.

11. The collapsible enclosure system of claim 10 wherein the corner joining element comprises:
a recess in one of the end panel frame or the side panel frame; and
a protrusion on the other of the end panel frame or the side panel frame whereby the protrusion mates with the recess to couple the plurality of end walls with the plurality of side walls.

12. The collapsible enclosure system of claim 3 wherein:
the side panel frame further comprises one or more side corner joining element coupling one or more of the end edge struts of the side walls to one or more of the side panel struts of the side walls;
the end panel frame further comprises one or more end corner joining element coupling the plurality of end edge struts of the end walls; and
the one or more side corner joining element configured to mate with the one or more end corner joining element whereby the plurality of end walls with the plurality of side walls are coupled.

13. The collapsible enclosure system of claim 1 further comprising an extension frame configured to couple with the side walls whereby the enclosure area is extended to define an extended enclosure area.

14. The collapsible enclosure system of claim 3 wherein:
the collapsible enclosure system further comprises an extension frame;
the plurality of side walls comprising a first set of side walls and a second set of side walls;
the plurality of end walls comprising a first end wall and a second end wall;
the first end wall configured to couple with the first set of side walls;
the second end wall configured to couple with the second set of side walls; and
the extension frame configured to couple with the first set of side walls and the second set of side walls whereby the enclosure area is extended to define an extended enclosure area.

15. The collapsible enclosure system of claim 14 wherein:
the extension frame further comprises one or more edge joining element; and
the one or more edge joining element of the extension frame configured to mate with one or more edge joining element on first set of side walls and with one or more edge joining element on the second set of side walls to couple the first set of side walls, the extension frame and the second set of side walls.

16. The collapsible enclosure system of claim 14 wherein:
the extension frame further comprises one or more corner joining element; and
the one or more corner joining element of the extension frame configured to mate with one or more corner joining element on first set of side walls and with one or more corner joining element on the second set of side walls to couple the first set of side walls, the extension frame and the second set of side walls.

17. A collapsible enclosure system configured to define an enclosure frame for an enclosure area to retain a living creature, the collapsible enclosure system comprising:
an extension frame;
a plurality of wall frames;
one or more of the plurality of wall frames being hingedly coupled to another of the wall frames; and
the plurality of wall frames and the extension frame configured to couple whereby the collapsible enclosure system defines an extended frame for an enclosure area to retain a living creature.

18. The collapsible enclosure system of claim 17 wherein the plurality of wall frames comprise a plurality of side panel frames comprising a plurality of hinged edge struts and a plurality of end edge struts.

19. The collapsible enclosure system of claim 18 wherein the plurality of wall frames further comprise a plurality of end panel frames comprising a plurality of end edge struts.

20. The collapsible enclosure system of claim 19 wherein the plurality of end panel frames further comprise one or more edge joining element configured to mate one of the plurality of the end panel frames with one of the plurality of the side panel frames.

21. The collapsible enclosure system of claim 19 wherein the plurality of end panel frames further comprise one or more corner joining element configured to mate one of the plurality of end panel frames with one of the plurality of the side panel frames.

22. The collapsible enclosure system of claim 19 further comprising:
an extension frame;
the plurality of side panel frames comprising a first set of side panel frames and a second set of side panel frames;
the plurality of end panel frames comprising a first end panel frame and a second end panel frame;
the first end panel frame configured to couple with the first set of side panel frames;
the second end panel frame configured to couple with the second set of side panel frames; and
the extension frame configured to couple with the first set of side panel frames and the second set of side panel frames whereby the enclosure frame for the enclosure area is extended.

23. A method of configuring a collapsible enclosure system to retain a living creature, the method comprising:
providing a collapsible enclosure system comprising:
a plurality of side walls and a plurality of end walls,
the plurality of side walls being hingedly coupled whereby the side walls define a middle side wall and a plurality of peripheral side walls, and
the plurality of end walls and the plurality of side walls configured to couple whereby the collapsible enclosure system defines an enclosure area to retain a living creature;
extending the plurality of side walls whereby the middle wall defines a back wall of the enclosure area, one of the plurality of peripheral side walls defines a top wall of the enclosure area and another of the plurality of peripheral side walls defines a bottom wall of the enclosure area; and
coupling the plurality of end walls to the plurality of side walls to define two end walls of the enclosure area.

24. The method of configuring a collapsible enclosure system to retain a living creature if claim 23 wherein coupling the plurality of end walls to the side walls to define two side walls of the enclosure area comprises mating one or more edge joining element of the end walls with one or more edge joining element of a the side walls.

25. The method of configuring a collapsible enclosure system to retain a living creature if claim 23 wherein coupling the plurality of end walls to the side walls to define two side walls of the enclosure area comprises mating one or more corner joining element of the end walls with one or more corner joining element of the side walls.
